(19) United States
(12) Patent Application Publication
(10) Pub. No.: US 2010/0091816 A1
(43) Pub. Date: Apr. 15, 2010

(54) TEMPERATURE SENSOR

(75) Inventors: Christian Schroll, Aalen (DE); Manfred Wetzko, Schriesheim (DE); Ralf Huck, Grosskrotzenburg (DE)

Correspondence Address: BUCHANAN, INGERSOLL & ROONEY PC, POST OFFICE BOX 1404, ALEXANDRIA, VA, 22313-1404, US

(73) Assignee: ABB Technology AG, Zurich (CH)

(21) Appl. No.: 12/540,157

(22) Filed: Aug. 12, 2009

(30) Foreign Application Priority Data
Aug. 13, 2008 (DE) 10 2008 038 980.3

(51) Int. Cl. G01K 7/02; G01K 1/16

(52) U.S. Cl. 374/165; 374/179; 374/163; 374/E01.021; 374/E07.004

(57) ABSTRACT

A temperature sensor is disclosed having at least one thermal measuring element which is arranged on a carrier body to convert a temperature into an electrical measurement signal which can be tapped off by electrical connecting lines as a result of a voltage supply. A generator is likewise fitted to the carrier body adjacent to the thermal measuring element to convert thermal energy into electrical energy, and to supply the voltage to the thermal measuring element.

### RELATED APPLICATIONS

This application claims priority under 35 U.S.C. §119 to German Patent Application No. 10 2008 038 980.3 filed in Germany on Aug. 13, 2008, the entire content of which is hereby incorporated by reference in its entirety.

### FIELD

The present disclosure relates to a temperature sensor having at least one thermal measuring element which is arranged on a carrier body to convert a temperature into an electrical measurement signal which can be tapped using electrical connecting lines as a result of a voltage supply.

### BACKGROUND INFORMATION

Temperature sensors which use temperature dependence of electrical resistance of particular materials as a measuring effect are used in a multiplicity of fields. Temperature sensors are found, inter alia, in ventilation and air-conditioning technology or in process engineering for measuring the temperature of flowing fluids. In this case, temperature sensors with and without a protective tube are used, for example, in the construction of containers and pipelines.

A control connection can be effected using bus systems such as FOUNDATION Field Bus, PROFIBUS PA or HART. In addition to the resistance elements which are most widespread as thermal measuring elements, there are also other thermocouples which convert the temperature into an electrical signal. The electrical signal from the thermal measuring element can be transformed into a standard signal in a transmitter by electronic means and forwarded to the superordinate controller.

A known temperature sensor is disclosed in DE 38 12 195 A1. A tubular carrier body is surrounded by a film on which a conductor track is printed in meandering fashion in the circumferential direction. Whereas the tubular carrier body is composed of ceramic, the printed conductor track is composed of platinum. The conductor track structure is protected by an electrically insulating glaze. The tubular carrier body with the thermal measuring element is accommodated in a tubular housing such that it is protected via spacers with respect to the inner wall of the housing. The temperature of a medium flowing around the thermal measuring element is transferred thereto. This temperature is determined by measuring the resistance of the conductor track.

An electrical voltage supply is used to operate such a temperature sensor. If the temperature sensor is connected to a data bus, this voltage can be supplied by a data bus via the measuring lines used. Otherwise, separate voltage supply modules are connected to an external electrical power supply system. If autonomous operation of the temperature sensor is desired, rechargeable batteries can be used for this purpose.

Supplying voltage via measuring lines of a data bus can involve complex associated cabling and, the power drawn can be restricted to only a few milliwatts in the case of known data buses. If, in order to avoid cabling complexity, recourse is had to local batteries instead, a limited battery capacity and the effort needed to monitor and replace used batteries can be a hindrance.

### SUMMARY

A temperature sensor is disclosed comprising at least one thermal measuring element arranged on a carrier body to convert a temperature into an electrical measurement signal which can be tapped by electrical connecting lines; and a generator, fitted to the carrier body adjacent to the thermal measuring element, to convert thermal energy into electrical energy to provide a voltage supply to said thermal measuring element

### BRIEF DESCRIPTION OF THE DRAWINGS

Further measures are described in more detail below in conjunction with the description of exemplary embodiments using figures, in which:

FIG. 1 shows a schematic side view of an exemplary temperature sensor with an autonomous voltage supply according to a first embodiment;

FIG. 2 shows a schematic illustration of a temperature sensor with an autonomous voltage supply according to a second embodiment; and

FIG. 3 shows a schematic view of a thermopile which is applied to a film.

### DETAILED DESCRIPTION

Exemplary temperature sensors suitable for industrial applications are disclosed which can be provided with a reliable autonomous voltage supply in a technically simple manner.

An exemplary generator which is likewise fitted to the carrier body adjacent to a thermal measuring element of the temperature sensor and is intended to convert thermal energy into electrical energy can be provided in order to supply voltage to the thermal measuring element.

Exemplary embodiments are configured such that, for example, the electrical power to operate the temperature sensor can be generated from the environment itself. It is possible to dispense with susceptible and high-maintenance battery solutions in the case of autonomous temperature sensors. In addition, possible power bottlenecks can be overcome by combining an environmental energy supply unit with a known supply, for example via a data bus. In addition, exemplary solutions according to the disclosure can be integrated in a space-saving manner in temperature sensors with known forms of construction.

An exemplary generator for converting the thermal energy into electrical energy can be in the form of a thermoelectric generator (TEG) composed of semiconductor materials. A thermoelectric generator converts heat directly into electrical energy. In particular, the so-called physical Peltier effect, in which a temperature difference generates a flow of current in a semiconductor, can be used in this case. The basis here is the contact between two semiconductors which have a different energy level in the conduction bands. An electrical voltage which is produced by thermodiffusion currents can be produced as a result of a temperature difference between two points having different temperatures.

In order to provide a voltage (e.g., a high voltage) despite prevailing narrow structural conditions of the carrier body, in the longitudinal direction of the carrier body, the thermal measuring element can connect a local first zone to a local second zone, between which there is a temperature difference which gives rise to the energy conversion effect. The higher the temperature difference which can be achieved thereby, the higher the efficiency of electrical voltage generation.

The thermal measuring element can be in the form of a short-circuit element for thermal resistance measurement, the thermal resistance of which element is less than the parallel-connected thermal resistances of the carrier body and the surrounding media. This can be achieved by producing the carrier body from stainless steel, for example. As a result, the thermal measuring element will assume the respective higher temperature.

Another measure includes at least partially surrounding the thermal measuring element with a thermal insulation layer. The layer may be composed of a plastic material which is pushed over the thermal measuring element in the form of a sleeve. This can, for example, improve the measuring effect.

The thermal measuring element can be provided with, for example, a ribbed metal heat sink near the measuring head. This supports the first zone with the lower temperature which is formed by the environment.

Whereas the measuring head of the temperature sensor is used to electrically connect the electrical measuring element and to condition signals, the measuring body can be in the form of a metal measuring tube around which the medium to be measured flows and which, for example, extends from the measuring head into a line or a container.

According to one exemplary embodiment of the thermal measuring element, the latter comprises a plurality of thermocouples which have been applied to a film and are electrically connected to one another by means of lines. The thermoelectric generators may be arranged on the film in the form of a thermopile.

Alternatively, the thermoelectric generators can be arranged in the region between the measuring head and the carrier body which extends therefrom in order to enable particularly space-saving accommodation in known temperature sensors.

When arranging thermocouples on a film, said thermocouples may be composed of organic materials which are printed on the film and are selected from a group comprising (e.g., consisting of): highly doped conjugated polymers or quasi-one-dimensional organic crystals. In terms of production technology, these organic materials are suitable for the film construction proposed here.

In order to achieve a pronounced measuring effect, it is also proposed in an exemplary embodiment that the film extends around the tubular carrier body in such a manner that the first half or approximately the first half of the thermocouples are in the first zone with, for example, a low temperature and the other half or approximately the other half of the thermocouples are in the second zone with a relatively higher temperature.

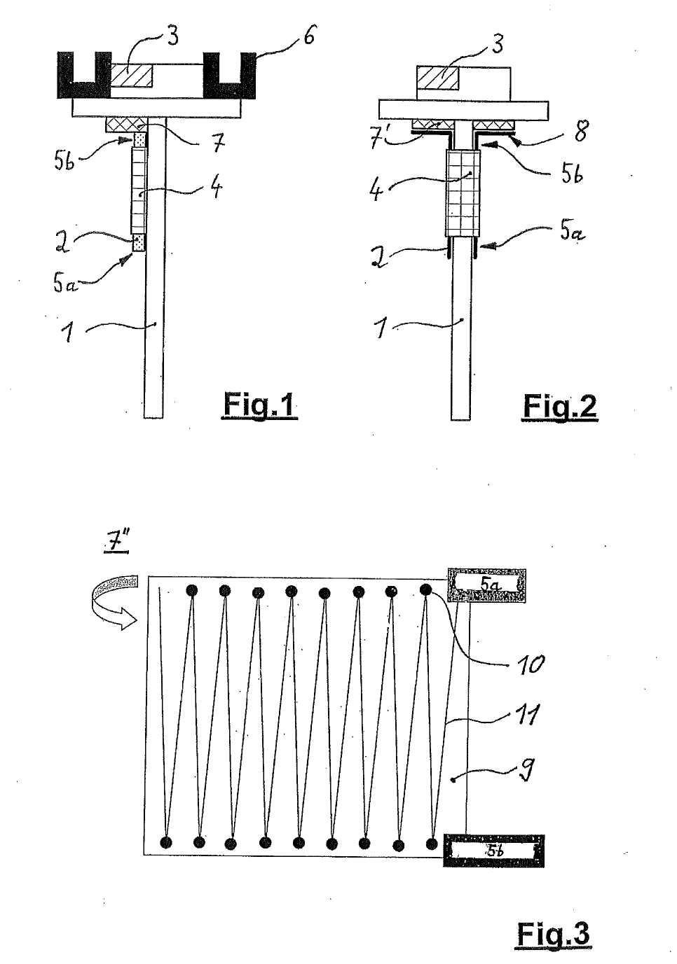

According to FIG. 1, an exemplary temperature sensor essentially comprises a tubular metal carrier body 1, to the outside of which a thermal measuring element 2 is fitted. The thermal measuring element can be composed of a metal selected from a group of highly thermally conductive materials comprising at least one of: silver, copper, aluminum; and a nonmetal selected from a group of materials comprising at least one of: aluminum nitride, and aluminum oxide. The carrier body 1 together with the thermal measuring element 2 extends from a measuring head 3. The measuring head 3 provides, for example, electrical signal conditioning and forwarding and contains, in this respect, an electronic unit for performing this function. The thermal measuring element 2 can be also partially coated with a plastic thermal insulation layer 4 in such a manner that the ends on both sides remain free, with the result that the temperature of the measurement medium acts at these points. In this manner, in the longitudinal direction of the carrier body 1, the thermal measuring element 2 connects a local first zone 5a, which is arranged adjacent to the measuring head 3, to a local second zone 5b which is arranged at the distal end of the thermal measuring element 2. There is a temperature difference between the two zones 5a and 5b since the first zone 5a is arranged close to the measuring head 3 which is outside the measurement medium, whereas the second zone 5b is in the medium to be measured which has a higher temperature.

In this exemplary embodiment, the thermal measuring element 2 is in the form of a short-circuit element for thermal resistance measurement, the thermal resistance of which element is less than the parallel-connected thermal resistances of the carrier body 1, which is composed of steel in this case, and the measurement medium. In this embodiment, the thermal measuring element 2 can, for example, be composed of silver. This material can significantly and characteristically change its electrical resistance on the basis of the temperature according to the law of resistance.

In order to increase the desired temperature difference between the first zone 5a and the second zone 5b, a ribbed heat sink 6 which is composed of light metal can be applied near the measuring head 3.

In order to autonomously supply voltage to the thermal measuring element 2, a generator 7 which is intended to convert thermal energy into electrical energy, can be composed of semiconductor materials in known manner. The generator 7 can be provided adjacent to the measuring head 3 in the region of the second zone 5b.

The generator can thus be configured as a thermoelectric generator 7 which electrically forms, with the thermal measuring element 2, a circuit which ends in a two-pole connection near the measuring head 3. The electronic unit integrated inside the measuring head 3 can ensure conversion into a standard signal which can be tapped off from the outside.

In contrast to the above-described embodiment of a temperature sensor, the thermal measuring element 2 can, for example, be essentially tubular in the embodiment according to FIG. 2 and have a flange region 8 near the measuring head 3. In this case too, the thermal measuring element 2 can be partially surrounded by a plastic thermal insulation layer 4 so as to leave the first zone 5a and the second zone 5b. The thermoelectric generator 7′ which extends annularly around the carrier body 1 can be mounted in a space-saving manner between this flange region 8 and the underside of the measuring head 3.

According to FIG. 3, a thermoelectric generator can also be produced on the basis of a film 9 by applying thermocouples 10 to the film and electrically connecting them to one another via electrical lines 11. The individual thermocouples 10 can be arranged on the film 9 in the form of a thermopile and composed of at least one of a printed organic material, and a highly doped conjugated polymer.

The film 9 can be wound around the tubular carrier body 1 in such a manner that one half of the thermocouples 10 is in a hot, first zone 5a and the other half of the thermocouples 10 is in a cooler, second zone 5b. This can produce a thermoelectric generator 7″ with a high degree of efficiency.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 Carrier body
2 Thermal measuring element
3 Measuring head
4 Insulation layer
5 Temperature zone
6 Heat sink
7 Generator
8 Flange section
9 Film
10 Thermocouple (exemplary)
11 Lines

What is claimed is:

1. A temperature sensor comprising:
at least one thermal measuring element arranged on a carrier body to convert a temperature into an electrical measurement signal which can be tapped by electrical connecting lines; and
a generator, fitted to the carrier body adjacent to the thermal measuring element, to convert thermal energy into electrical energy to provide a voltage supply to said thermal measuring element.

2. The temperature sensor as claimed in claim 1, wherein the generator for converting thermal energy into electrical energy is a thermoelectric generator composed of semiconductor material.

3. The temperature sensor as claimed in claim 1, wherein, in a longitudinal direction of the carrier body, the thermal measuring element connects a local first zone to a local second zone, between which there is a temperature difference.

4. The temperature sensor as claimed in claim 1, wherein the thermal measuring element is a short-circuit element for thermal resistance measurement, a thermal resistance of which element is less than parallel-connected thermal resistances of the carrier body and surrounding media.

5. The temperature sensor as claimed in claim 1, wherein the thermal measuring element is at least partially surrounded by a thermal insulation layer.

6. The temperature sensor as claimed in claim 1, wherein the thermal measuring element is composed of:
a metal selected from a group of highly thermally conductive materials comprising at least one of: silver, copper, aluminum; and a nonmetal selected from a group of materials comprising at least one of: aluminum nitride, and aluminum oxide.

7. The temperature sensor as claimed in claim 1, wherein the carrier body is a metal measuring tube, configured to contact a flow of a medium to be measured, and at a proximal end of which a measuring head for electrical signal conditioning and forwarding is arranged.

8. The temperature sensor as claimed in claim 7, wherein the measuring head includes a ribbed metal heat sink.

9. The temperature sensor as claimed in claim 1, wherein the generator comprises:
a plurality of thermocouples which have been applied to a film and are electrically connected to one another by lines to form a thermoelectric generator.

10. The temperature sensor as claimed in claim 1, wherein the generator comprises:
a thermocouple arranged as a thermopile and applied to a film to form a thermoelectric generator.

11. The temperature sensor as claimed in claim 1, wherein the generator comprises:
an organic material selected from a group comprising at least one of a highly doped conjugated polymer, and a quasi-one-dimensional organic crystal printed on a film as thermoelectric generator.

12. The temperature sensor as claimed in claim 3, wherein the generator comprises:
a plurality of thermocouples which have been applied to a film and are electrically connected to one another by lines to form a thermoelectric generator.

13. The temperature sensor as claimed in claim 9, wherein the film extends around the carrier body such that one half of the thermocouples is in a first zone and the other half of the thermocouples is in a second zone.

14. The temperature sensor as claimed in claim 13, wherein the thermocouples are arranged as a thermopile and applied to a film to form the thermoelectric generator.

15. The temperature sensor as claimed in claim 14, wherein the generator comprises:
an organic material selected from a group comprising at least one of a highly doped conjugated polymer, and a quasi-one-dimensional organic crystal printed on the film as thermoelectric generator.
